(19) United States
(12) Patent Application Publication
(10) Pub. No.: US 2012/0159363 A1
(43) Pub. Date: Jun. 21, 2012

(54) Z-ORDER BANDS

(75) Inventors: Gabriel DeBacker, Carnation, WA (US); Alex Snitkovskiv, Renton, WA (US); Chris Guzak, Kirkland, WA (US); John Stephens, Redmond, WA (US); Thomas Olsen, Redmond, WA (US); Mohamed Sadek, Sammamish, WA (US); Hirofumi Yamamoto, Bellevue, WA (US); Robert Jarrett, Shohomish, WA (US); David Abzarian, Kenmore, WA (US); Alice Tang, Seattle, WA (US); Jennifer Nan, Seattle, WA (US); Adrian Ford, Wallingford (GB); Chaitanya Sareen, Seattle, WA (US)

(73) Assignee: MICROSOFT CORPORATION, Redmond, WA (US)

(21) Appl. No.: 12/970,904

(22) Filed: Dec. 16, 2010

(51) Int. Cl. G06F 3/048

(52) U.S. Cl. 715/766

(57) ABSTRACT

The subject disclosure relates to managing z-dimensional ordering of elements within a computing system display through the use of z-order bands. As described herein, z-order bands are utilized to arrange windows and other graphics corresponding to respective application types. A policy engine controls which windows and/or other graphical elements can enter and exit each band. Graphical elements within a given band can additionally be subject to per-band properties corresponding to the band and/or user preferences. As additionally described herein, z-order bands and/or other suitable mechanisms are utilized to facilitate registration watermarking for a computing environment by rendering a registration watermark display upon determining that one or more licensed elements of a computing system have not been registered. The registration watermark display is assigned a z-order band that enables its display over all other graphical elements associated with the computing system and prevents other graphical elements from interfering with its display.

### TECHNICAL FIELD

The subject disclosure relates to computing system display management, and, more specifically, to establishing rules that facilitate visibility control for graphical items associated with a computing display.

### BACKGROUND

Computing systems utilize various output mechanisms to relay information to system users. For example, computing systems utilize display screens to render graphical elements, such as windows, text, buttons and/or other control elements, etc., for visualization of the graphical elements by a user. Conventionally, graphical elements such as windows are configured with a set of coordinates (e.g., x and y coordinates) that specify an area of the display at which the elements are to be displayed. In addition, windows and other graphical elements are conventionally managed by a z-order stack and/or other similar mechanisms that control the order in which graphics are displayed in the event of an overlap. For example, if two windows occupy a common area in two-dimensional display space, the z-order stack can be used to determine which window is displayed in front of the other window, thereby making the topmost window visible and the bottommost window invisible at the point of overlap.

In traditional display management systems, windows share the same z-order stack. However, this single stack poses difficulties when multiple windows or other graphical elements desire to be at the top of the z-order due to contention between the graphical elements for the top position of the stack. In addition, conventional display management mechanisms provide no means by which relative z-order positioning can be maintained for different windows or other graphics, as graphical elements are free to move within the single stack. Further, the lack of z-order control in conventional systems results in significant difficulty in protecting portions of user experience as well as applying windowing rules to subsets of windows. Accordingly, it would be desirable to implement display management systems that provide improved z-order control.

The above-described deficiencies of today's computing system and resource management techniques are merely intended to provide an overview of some of the problems of conventional systems, and are not intended to be exhaustive. Other problems with conventional systems and corresponding benefits of the various non-limiting embodiments described herein may become further apparent upon review of the following description.

### SUMMARY

A simplified summary is provided herein to help enable a basic or general understanding of various aspects of exemplary, non-limiting embodiments that follow in the more detailed description and the accompanying drawings. This summary is not intended, however, as an extensive or exhaustive overview. Instead, the sole purpose of this summary is to present some concepts related to some exemplary non-limiting embodiments in a simplified form as a prelude to the more detailed description of the various embodiments that follow.

In one or more embodiments, windows and other display elements are managed via multiple z-order stacks. Respective sets of one or more z-order stacks, referred to herein as z-order bands, are utilized to arrange windows and other graphics corresponding to respective application types. In addition, the display management system controls which windows and/or other graphical elements can enter and exit each band. In one example, graphical elements within a given band can additionally be subject to per-band properties, such as windowing rules, format properties, etc., corresponding to the band. Additionally or alternatively, assignment of graphics to z-order bands and/or configuration of graphics within z-order bands can be controlled based at least in part on user input.

In other embodiments herein, z-order bands and/or other suitable mechanisms are utilized to facilitate registration watermarking for a computing environment. One or more licensed elements of a computing environment, such as applications, an operating system, etc., can utilize a license registration process by which the license(s) corresponding to the licensed elements of the computing environment are verified and/or otherwise registered. In addition, the computing environment can manage the rendering of windows and/or other display elements as generally described above. Upon determining that the licensed elements of the computing environment have not been successfully registered (e.g., upon fulfillment of other conditions, such as the passage of a predetermined amount of time, etc.), the computing system renders a registration watermark display on the display screen. The registration watermark display is assigned a z-order band that enables its display over all other graphical elements associated with the computing system. In addition, the computing system prevents any other graphical elements from entering the z-order band associated with the registration watermark display and interfering with its visibility.

These and other embodiments are described in more detail below.

### BRIEF DESCRIPTION OF THE DRAWINGS

Various non-limiting embodiments are further described with reference to the accompanying drawings in which:

FIG. 1 is a block diagram showing a simplified view of a display management system in accordance with one or more embodiments;

FIGS. 2-5 are illustrative views of exemplary window hierarchies;

FIG. 6 is a block diagram showing a z-order display band control system in accordance with one or more embodiments;

FIG. 7 is an illustrative overview of z-order band functionality in accordance with one or more embodiments;

FIG. 8 is an illustrative view of an exemplary z-order band ordering in accordance with one or more embodiments;

FIG. 9 is a block diagram showing an exemplary z-order band management component in accordance with one or more embodiments;

FIG. 10 is a block diagram showing a per-band display ordering system in accordance with one or more embodiments;

FIG. 11 is a block diagram showing a registration-based watermarking system in accordance with one or more embodiments;

FIG. 12 is a flow diagram illustrating an exemplary non-limiting process for z-order display management;

FIG. 13 is another flow diagram illustrating an exemplary non-limiting process for registration watermarking of a computer display;

FIG. 14 is a block diagram representing exemplary non-limiting networked environments in which various embodiments described herein can be implemented; and

FIG. 15 is a block diagram representing an exemplary non-limiting computing system or operating environment in which one or more aspects of various embodiments described herein can be implemented.

### DETAILED DESCRIPTION OVERVIEW

By way of introduction, computing systems render graphical items such as windows, text, buttons and/or other control elements, etc., on display screens and/or other display devices. Windows and other graphics are configured with (x, y) coordinates and/or other means to specify their occupied display area. In addition, a window and/or other graphical item is further configured with one or more parameters that determine whether the graphical item is to be displayed in front of or behind other graphical items, e.g., defining the z-dimensional order (or z-order) of the graphical item. For example, in the event that two windows overlap, the z-order of the windows is utilized to determine which window is displayed in front of the other.

Conventionally, windows in a computing environment utilize a common z-order stack. However, this results in contention between windows for the top position in the stack. In addition, a single-stack configuration provides no means by which relative z-order positioning can be maintained for different windows or other graphics, as windows and other graphics are free to move within the single stack. Further, use of a single z-order stack results in difficulty in protecting specific parts of the overall user experience portions as well as applying windowing rules to subsets of windows.

In view of at least the above shortcomings of conventional display management systems, windows and other display elements are managed in accordance with various embodiments herein via the use of z-order bands, which enable separation of z-order into multiple z-order stacks. In one example, z-order bands are utilized to arrange windows and other graphics corresponding to respective applications and/or application technologies (e.g., accessibility, media playback, word processing, etc.). A policy engine and/or other mechanisms are utilized to control entry into each band and/or movement between bands, thereby reducing contention between windows for z-order position within a z-order band and improving user experience. Further, as z-order bands can be utilized to separate application technologies, contention between applications of respective technologies for position within z-order is mitigated, thereby increasing system performance.

In some embodiments herein, z-order bands can be associated with various properties, which can in turn be utilized by windows and/or other graphics assigned to the bands. For example, windows and other graphics associated with a z-order band can be given display properties such as windowing rules, format properties, or the like, that correspond to the band. In another example, per-band ordering rules are implemented to provide further granularity for z-order control within a specific band. In further examples provided herein, operations such as assignment of graphics to z-order bands, configuration of graphics within z-order bands, or the like, can be performed based at least in part on user preferences and/or other user input. In still other examples provided herein, z-order bands utilize a modular structure that enables addition, removal, and/or reordering of bands and/or other suitable operations.

In other embodiments described herein, license registration watermarking for a computing environment is enabled through the use of z-order bands or other suitable mechanisms. In the event that one or more licensed elements of a computing environment, such as applications, an operating system, etc., utilize a license registration process by which the license(s) corresponding to the licensed elements of the computing environment are verified, activated, and/or otherwise registered, the computing system can verify that the license(s) have been successfully registered. In response to determining that the licensed elements of the computing environment have not been successfully registered (e.g., upon fulfillment of other conditions, such as the passage of a predetermined amount of time, etc.), a registration watermark display is rendered on the display screen. The registration watermark display is assigned a z-order band that enables its display over all other graphical elements associated with the computing system. In addition, the computing system prevents any other graphical elements from entering the z-order band associated with the registration watermark display and interfering with its visibility. In one example, the registration watermark display can be utilized to obscure other graphics associated with the computing system, thereby preventing unauthorized or unlicensed use of the licensed elements of the computing system.

By utilizing z-order bands as generally described herein, respective portions of user experience can be protected. For example, by having different bands for different application types, windows of a first application type can be configured such that they can never intrude on top of windows of a second application type. Further, bands can be used to keep windows in a relative position to other windows. For instance, bands can be used to ensure that accessibility windows are displayed on top of all other windows in the system. Additionally or alternatively, separate bands can be used for different technologies, enabling addition and/or removal of technologies via their corresponding bands with minimal impact to other technologies as well as facilitating different treatment of windows and/or other graphics corresponding to different technologies. In another example, bands can be used to provide a mechanism to apply and enforce behavior for a set of windows and/or other graphics. For example, a band can be configured to ensure that all windows and/or other graphics within the band adhere to specific style guidelines, window size and position guidelines, or the like.

In one embodiment, a graphical display management system as described herein includes a band management component configured to define a set of z-order bands, to associate relative z-order ranges with z-order bands of the set of z-order bands, to assign display elements to respective z-order bands of the set of z-order bands, and to generate a linear order of the z-order bands such that first display elements assigned to a first z-order band of the set of z-order bands associated with a first z-order range are displayed in front of display elements assigned to a second z-order band of the set of z-order bands associated with a second z-order range that is deeper than the first z-order range. The system further includes a display component configured to render the display elements according to the linear order of the z-order bands.

In one example, the z-order bands respectively correspond to application types. In other examples, the band management component includes a policy engine component configured to maintain a set of policies utilized by the band management component to assign the display elements to the respective z-order bands of the set of z-order bands. The policy engine component can be further configured to maintain a set of entrance policies and a set of exit policies that respectively control entry and exit of the display elements into respective z-order bands of the set of z-order bands. Additionally or alternatively, the policy engine component can be configured to maintain a set of enforcement policies that control movement of the display elements between z-order bands of the set of z-order bands.

In some implementations, respective z-order bands are configured with display properties, and the display component is further configured to render the display elements according to the display properties with which their respectively assigned z-order bands are configured. The display properties can include, e.g., display format properties, windowing rules, full-screen display properties, or graphical element sizes. In another example, the band management component is further configured to assign the display elements to the respective z-order bands of the set of z-order bands based at least in part on user preferences.

In further implementations, the band management component includes a band creation component configured to create at least one z-order band, to assign the at least one z-order band to at least one corresponding z-order range, and to associate the at least one z-order band with the set of z-order bands. Additionally or alternatively, the band management component can include a band reordering component configured to alter the z-order ranges with which respective z-order bands of the set of z-order bands are associated. In one example, the band reordering component can be further configured to alter the z-order ranges with which respective z-order bands of the set of z-order bands are associated based at least in part on user input.

In additional implementations, the system can further include a per-band ordering component configured to associate z-order positions with display elements assigned to a z-order band of the set of z-order bands. Accordingly, the display component can be further configured to render the display elements assigned to the z-order band of the set of z-order bands according to respective z-order positions such that display elements associated with a first z-order position are displayed in front of display elements assigned to a second z-order position that is deeper than the first z-order position.

In still other implementations, the system can include a registration component configured to facilitate registration of a computing environment associated with the display elements. In such an example, the band management component can be further configured to generate an unregistered display band and associate an unregistered graphical display with the unregistered display band if the computing environment associated with the system has not been registered by the registration component. Further, the display component can be further configured to render the unregistered graphical display associated with the unregistered display band in front of the display elements if the computing environment associated with the system has not been registered by the registration component.

In another embodiment, a method for managing a computer display includes associating a set of z-order display bands with respective depth ranges and application types, assigning graphical elements to respective z-order display bands according to application types associated with the graphical elements, ordering the z-order display bands such that a first set of graphical elements assigned to a first z-order display band associated with a first depth range are displayed over a second set of graphical elements assigned to a second z-order display band associated with a second depth range that is z-dimensionally deeper than the first depth range, and displaying the graphical elements according to the ordering.

In one example, the graphical elements are assigned to the respective z-order display bands of the set of z-order display bands based at least in part on a set of band management policies. For example, the assigning can include controlling entry of graphical elements into the respective z-order display bands based at least in part on a set of band entrance policies, controlling exit of graphical elements into the respective z-order display bands of the set of z-order display bands based at least in part on a set of band exit policies, and/or controlling movement of graphical elements between z-order display bands based at least in part on a set of band enforcement policies.

In another example, the method can additionally include associating z-order display bands with respective display properties that include, e.g., display format properties, windowing rules, full-screen display properties, and/or graphical element sizes. The graphical elements are then displayed according to the display properties associated with the z-order display bands to which the graphical elements are assigned. In a further example, graphical elements are assigned to respective z-order display bands based at least in part on user preferences.

In a further example, the method additionally includes modifying the set of z-order display bands via at least one of adding one or more z-order display bands to the set of z-order display bands, removing one or more z-order display bands from the set of z-order display bands, combining one or more z-order display bands of the set of z-order display bands, or reordering depth ranges associated with one or more z-order display bands of the set of z-order display bands.

In an additional embodiment, a system that facilitates graphical display includes a registration component configured to facilitate registration of a license for at least one licensed element of a computing system. The system further includes a band management component configured to associate a registration display with a registration display band and to associate respective graphics of the computing system with at least one system display band. The system additionally includes a display component configured to render the respective graphics and, if the license has not been registered via the registration component, to render the registration display associated with the registration display band in front of the respective graphics and to prevent the respective graphics from being moved in front of the registration display.

Herein, an overview of some of the embodiments for achieving computing system display management has been presented above. As a roadmap for what follows next, various exemplary, non-limiting embodiments and features for distributed transaction management are described in more detail. Then, some non-limiting implementations and examples are given for additional illustration, followed by representative network and computing environments in which such embodiments and/or features can be implemented.

### Z-Order Bands

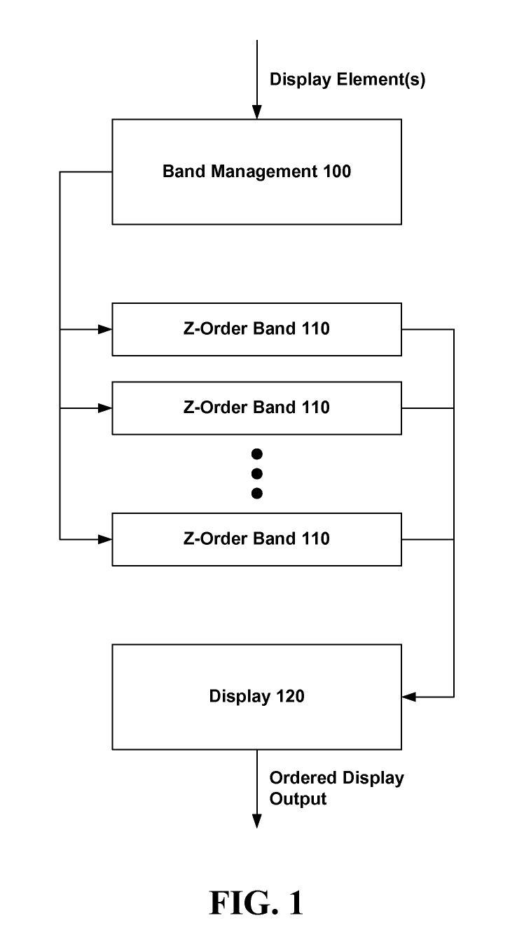

By way of further description with respect to one or more non-limiting ways to conduct z-order management, a block diagram of an exemplary display management system is illustrated generally by FIG. 1. In an embodiment, windows, text, graphics, and/or other display elements can be rendered on an output display according to, for example, location coordinates (e.g., x and y coordinates) and z-order parameters. As used herein, z-order refers to depth (e.g., the z dimension) and specifies which pixels are to be displayed in the event that multiple display elements overlap. Stated another way, z-order is utilized to specify which graphical element is rendered in front of other graphical elements in the event of an overlap.

Conventionally, all windows and/or other graphics share the same z-order stack. However, as noted above, use of a single stack presents difficulties resulting from graphical items contending for the top position of the stack. As further noted above, there is conventionally no way to maintain relative z-order positioning of different graphical items, as the graphical items are free to move around in the single stack. As additionally noted above, there is conventionally no readily available manner in which windowing rules can be applied to subsets of windows.

Accordingly, the system illustrated by FIG. 1 can implement z-order bands 110, which are sets of one or more z-order stacks. As used herein, the term “z-order stack” refers to a conceptual stack that facilitates z-dimensional ordering of graphical elements of a computing environment. In one example, a band management component 100 and/or other suitable mechanisms can obtain information relating to display element(s) to be rendered and assign the display element(s) to respective z-order bands 110 based on various criteria, as described in further detail herein. In an embodiment, z-order bands 110 are composed of respective sets of z-order stacks, which facilitate separation between windows and/or other graphics corresponding to different applications, application types, technologies, and/or any other suitable groupings and prevent contention between the respective groupings for z-order position. Upon assignment of respective display elements to z-order bands 110, the display elements can be rendered by a display component 120 and/or other suitable means according to their assigned z-order bands 110 or other properties. In one embodiment, z-order bands 110 serve as zones in which sets of windows and/or other graphics are constrained in z-order. Accordingly, z-order bands 110 can be utilized for a set of graphical display items without changing the physical dimensions of the items (e.g., defined based on x and y coordinates and/or other mechanisms).

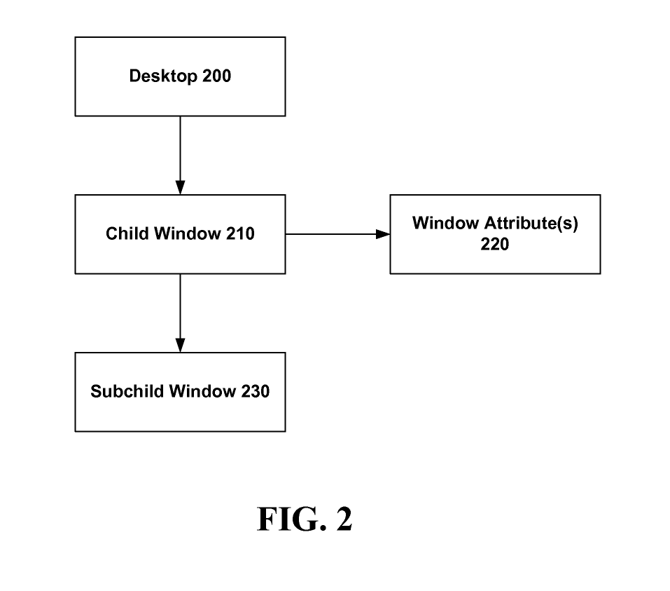

In an embodiment, z-order bands as described herein can be utilized to provide additional functionality to a display window hierarchy. For example, FIG. 2 illustrates an exemplary window hierarchy associated with a desktop 200, which is defined herein as the entire display area associated with a computing system. The desktop is associated with one or more child windows 210. As used herein, child windows 210 to a desktop 200 are also referred to as top-level windows. The child window 210 can be associated with one or more window attributes 220, such as maximize and/or minimize buttons, scroll bars, or the like. As further shown by FIG. 2, a child window 210 can itself be associated with one or more child windows, referred to herein as subchild windows 230. Subchild windows 230 can include, for example, control windows corresponding to an application running in the corresponding child window 210, dialog boxes, text, etc.

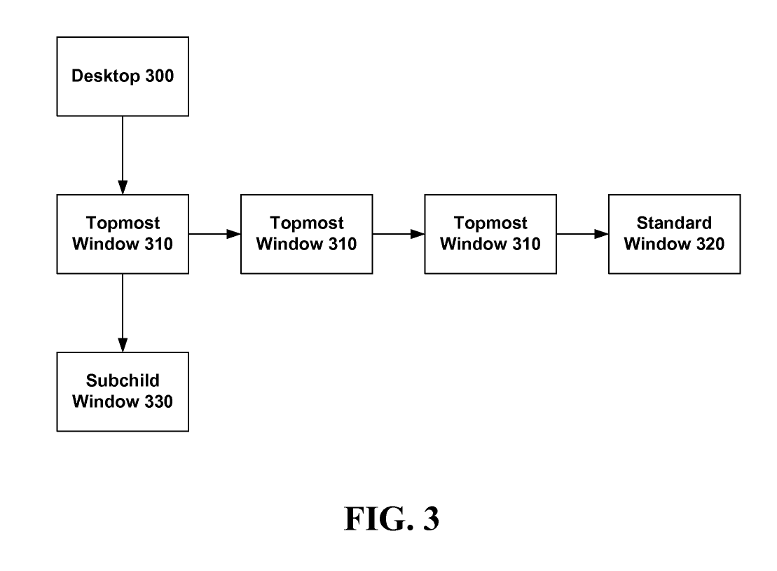

In one example, respective windows associated with a display environment can leverage relative window ordering to set the respective positions of the windows in z-order. For example, as shown in FIG. 3, a desktop 300 can be associated with one or more windows 310-320, each of which can in turn be associated with one or more subchild windows 330. As further shown in FIG. 3, ordering of windows 310-320 can be performed according to various criteria. For example, a “top-most” window style can be employed in order to separate windows 310-320 into topmost windows 310 and standard windows 320, such that topmost windows 310 occupy higher positions in z-order than standard windows 320. In one example, a window can be made a topmost window 310 by setting a flag and/or other suitable indicator associated with the window. In accordance with one aspect, respective topmost windows 310 can be configured to be displayed on top of standard windows 320. Further, the last window to be identified as a topmost window 310 can be displayed on top of other topmost windows 310. In this manner, topmost windows 310 can be conceptualized as a second window stack, which is on top of the standard stack, into which any window can enter and for which any window can contend for top position.

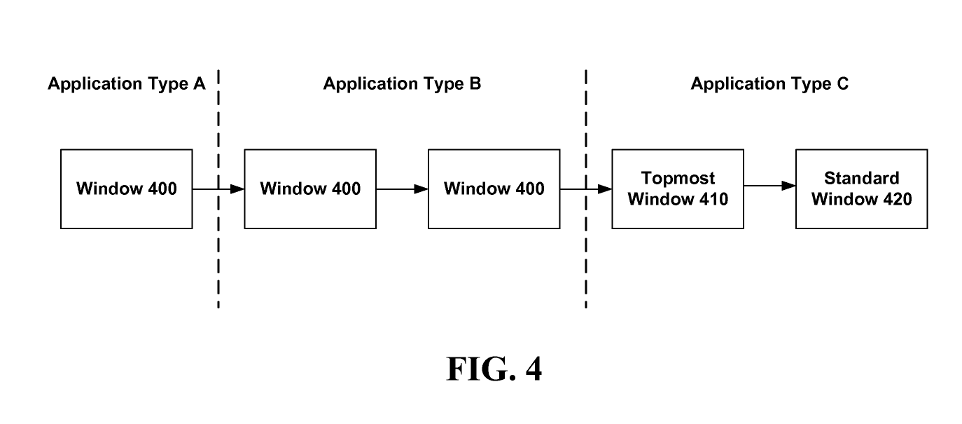

In conventional display management systems, no mechanisms are provided to prevent windows from associating with the top-most window style. Accordingly, windows in conventional display management systems contend for top position in the z-order stack, which may in some cases result in undesired windows interfering with a desired topmost window. Accordingly, a display management system as described herein can employ z-order bands to group windows according to their application types. An example of sorting that can be facilitated via the use of z-order bands is illustrated by FIG. 4. As FIG. 4 illustrates, respective windows 400-420 of different application types, denoted as application types A, B and C, can be associated with respective z-order bands such that z-order positioning between the respective windows 400-420 is regulated to prevent contention between windows 400-420 of different application types for z-order position. In one example, z-order bands can be associated with each application type, e.g., a first z-order band can be associated with application type A, a second z-order band can be associated with application type B, a third z-order band can be associated with application type C, and so on. It can be appreciated, however, that any suitable mapping between application types and z-order bands can be utilized and that, unless explicitly stated otherwise, the subject matter described herein is not intended to be limited to any specific mapping.

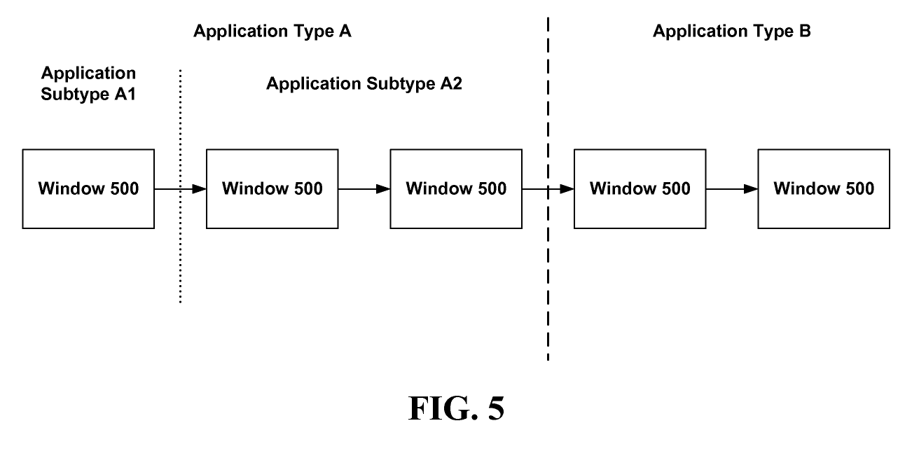

In an embodiment, a display management system employing z-order bands can implement one or more policies that enforce entry of windows 400-420 into respective z-order bands and/or movement of windows 400-420 between z-order bands, thereby creating concretely defined z-order ranges for windows of different application types. In another example, windows and/or other graphics within a given z-order band can be ordered according to any suitable mechanism(s). For example, the top-most window style described above can be applied to one or more z-order bands, as shown by topmost window 410 and standard window 400 corresponding to application type C. In another example illustrated by FIG. 5, an application type can be further divided into subtypes, which can correspond to z-order bands or sub-bands (e.g., nested z-order bands) and/or a priority ordering for windows 500 corresponding to the application type.

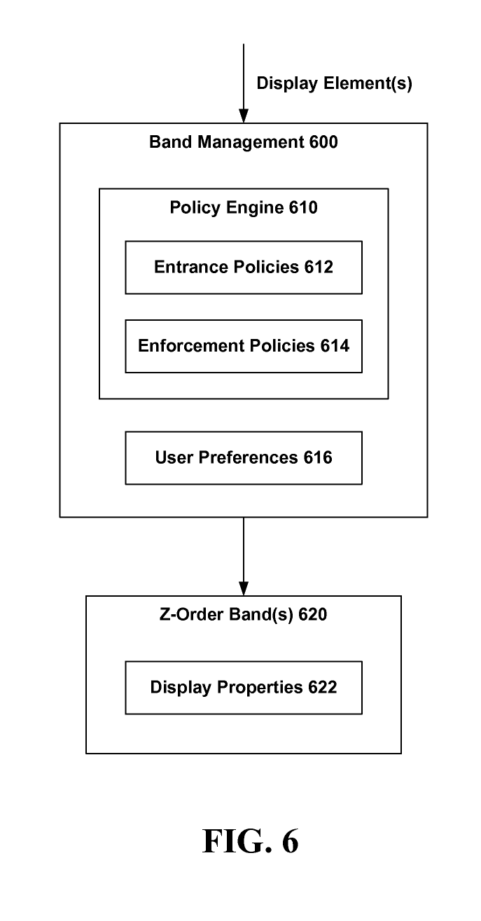

Turning next to FIG. 6, a block diagram of an exemplary z-order display band control system in accordance with an embodiment is illustrated. The system includes a band management component 600, which can operate as generally described herein to assign display elements to respective z-order bands 620. In an embodiment, in order to prevent display elements from associating with inappropriate z-order bands 620, band management component 600 can utilize a policy engine component 610 and/or other suitable mechanisms to conduct and enforce assignments of display elements to respective z-order bands 620.

As shown in FIG. 6, policy engine component 610 can implement entrance policies 612, enforcement policies 614, and/or any other suitable policies to control association of display elements with z-order bands 620 and prevent display elements from associating with z-order bands 620 that would cause interference with other display elements. In one example, entrance policies 612 can be utilized to control entry into respective z-order bands 620. For example, based on a set of entrance policies 612, band management component 600 can analyze respective windows or other graphical elements, and/or applications associated with the windows or other graphical elements, to determine which z-order band 620 to assign to the elements. In another example, enforcement policies 614 are utilized to enforce existing z-order band assignments for respective display elements. Thus, for example, band management component 600 can utilize a set of enforcement policies 614 to prevent a display element from changing its assigned z-order band 620 without authorization.

As further illustrated in FIG. 6, band management component 600 can further operate based at least in part on user preferences 616 and/or other user input. For example, a user can specify a z-order configuration (e.g., messaging windows are to be placed in front of media playback windows, word processing windows are to be placed in front of web browsing windows, etc.), which can be utilized by band management component 600 in assigning display elements to z-order bands 620. In an embodiment, user preferences 616 can specify sets or “zones” of applications, which are then given higher or lower z-order priority based on the state of the computing system. By way of specific example, media, gaming and entertainment applications can be given higher z-order priority when a “play zone” is active, while word processing, spreadsheet, and academic applications can be given higher z-order priority when a “work zone” is active. In another example, user preferences 616 can be utilized to isolate a single application such that only graphical items corresponding to the desired application are visible relative to the desktop.

Additionally or alternatively, band management component 600 can operate according to a default ordering to protect display items of one or more application types or technologies from interference from display items of other application types or technologies. In one example, user preferences 616 can facilitate complete or partial modification of the default ordering.

As further shown by FIG. 6, z-order bands 620 can be associated with display properties 622, which can include style guidelines, window size/position guidelines, and/or other suitable properties for display elements associated with the z-order bands 620. Examples of display properties 622 that can be associated with a z-order band 620 include, but are not limited to, full screen display preferences, windowing rules, display styles (e.g., specifying colors, fonts, styles, etc., to be used within windows and/or other graphical items in the band), or the like. In one example, policy engine component 610 (e.g., via enforcement policies 614) can be utilized to ensure that all display elements within a given z-order band 620 adhere to the display properties 622 of the band. In another example, display properties 622 can be set based at least in part on user preferences 616. In one embodiment, display properties 622 can vary between different z-order bands 620 to accommodate the specific application types (e.g., word processing, media playback, web browsing, instant messaging, etc.) corresponding to the z-order bands 620. In another embodiment, policies implemented by policy engine component 610 can operate on subsets of display elements assigned to a z-order band 620 in addition to, or in place of, the entire z-order band 620.

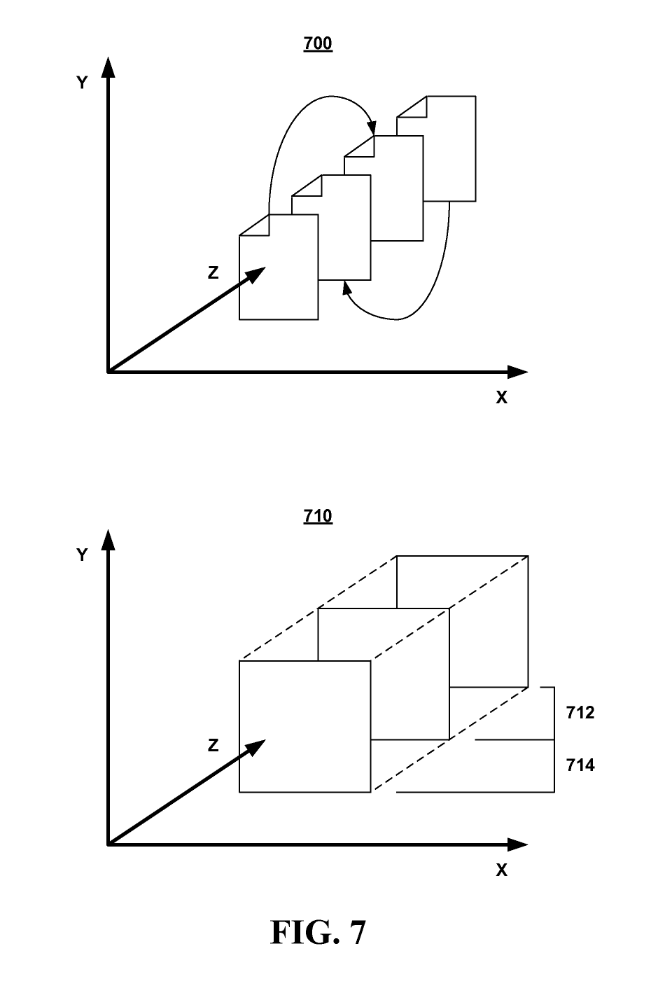

As described herein, z-order bands can be utilized to enforce policy for respective positions in a z-order stack. For example, diagram 700 in FIG. 7 shows an example z-order stack that includes a set of graphical elements. As diagram 700 illustrates, in the absence of enforceable z-order policy, the graphical elements can move freely within the z-order stack. However, by implementing z-order bands as shown by diagram 710, graphical elements can be restricted to segments 712-714 of the z-order stack defined by the z-order bands. By doing so, z-order bands can be utilized to enforce what can and cannot be seen on a display screen by controlling what visually is rendered at the top level of the display. While the z-order bands are shown as defined by a set of “walls” in diagram 710, it should nonetheless be appreciated that the bands can be transparently implemented such that graphics from lower z-order bands are visible in the absence of other graphics in higher z-order bands in the same location.

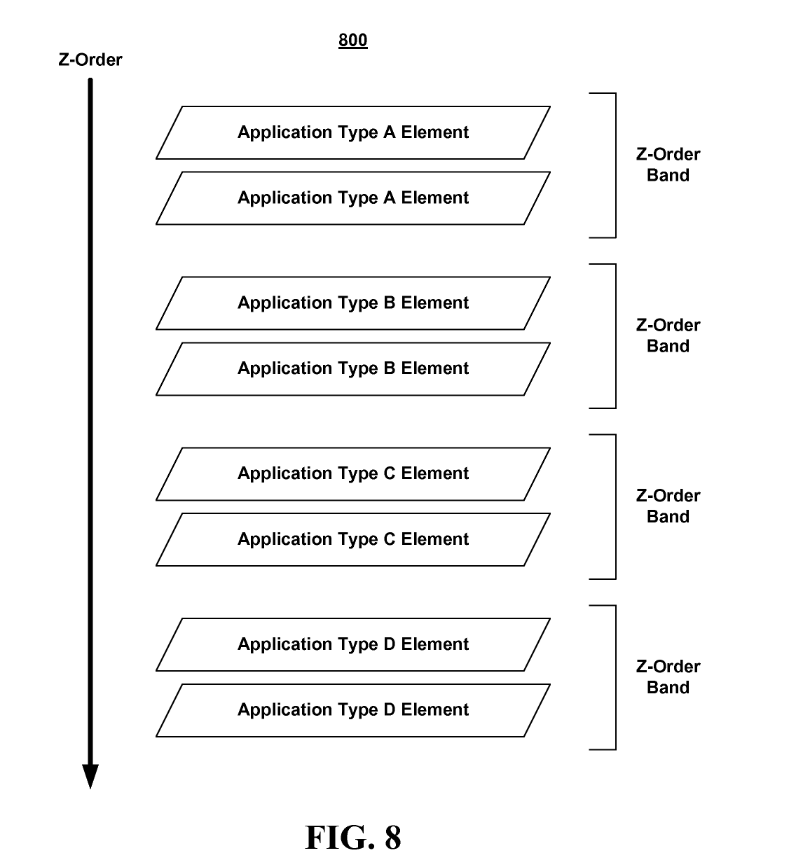

As further described herein, z-order bands can also be utilized to effectively establish priorities for the display of items corresponding to different application types. For example, as shown by diagram 800 in FIG. 8, a z-order stack can be divided into a set of z-order bands, each of which correspond to one or more application types. Accordingly, z-order bands can establish certain technologies and/or application types as having higher priority than others with regard to display, thereby enabling “shelves” of display. In another example, assigning respective application types to different z-order bands can be used to keep windows in a relative position to other windows. By way of specific, non-limiting example, bands can be utilized to ensure that accessibility windows are displayed on top of all other windows in the system.

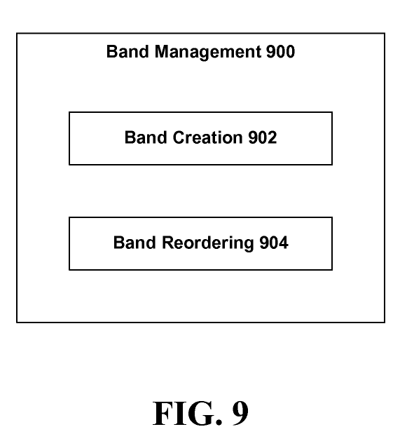

Turning next to FIG. 9, an exemplary band management component 900 is illustrated in accordance with one or more embodiments. As described above, a z-order stack corresponding to a graphical display system can be divided into a set of z-order bands. In one example, the z-order bands can be defined in a modular fashion to enable creation of new bands, removal of bands, reordering of bands, and/or other suitable operations. For example, band management component 900 can include a band creation component 902 for creating one or more new z-order bands, a band reordering component 904 for reordering respective z-order bands, and/or any other suitable mechanisms to manage a set of z-order bands. In an embodiment, separate bands can be utilized for different technologies. Accordingly, band management component 900 can (e.g., via band creation component 902, band reordering component 904, and/or other mechanisms) add, remove, or reorder one or more bands with minimal impact to the remaining bands.

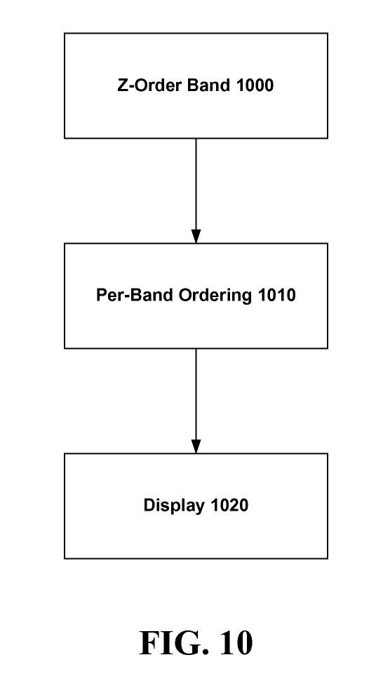

In another embodiment, further ordering granularity can be provided within one or more z-order bands. For example, as shown by FIG. 10, display elements assigned to a z-order band 1000 can be further processed by a per-band ordering component 1010 and/or other suitable mechanisms, which can order the display elements within the band prior to rendering by a display component 1020. Per-band ordering component 1010 can operate according to any suitable criteria, such as applications or application types, user input or preferences, or the like.

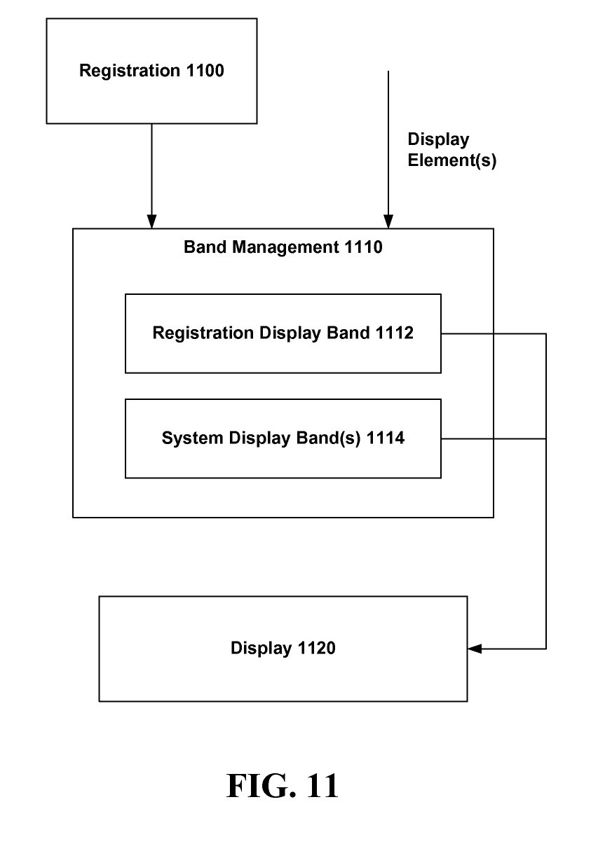

In a further embodiment, z-order bands as described herein can further be utilized to provide license registration watermarking functionality. For example, as illustrated by FIG. 11, one or more licensed elements of a computing environment, such as applications, an operating system, etc., can utilize a license registration process by which the license(s) corresponding to the licensed elements of the computing environment are verified and/or otherwise registered (e.g., via a registration component 1100). In addition, the computing environment can utilize a band management component 1100 and/or other suitable mechanisms to manage the rendering of windows and/or other display elements as described in accordance with various embodiments herein.

In an embodiment, band management component 1100 can maintain a registration watermark display on a registration display band 1112. The registration watermark display can include, e.g., instructions or other information for registering the licensed computing system element(s) and/or any other suitable information or graphical items. Upon determining that the licensed elements of the computing environment have not been successfully registered (e.g., upon fulfillment of other conditions, such as the passage of a predetermined amount of time, etc.), band management component 1110 can provide the display associated with the registration display band 1112 along with other display elements on one or more system display bands 1114 to a display component 1120 for rendering.

The registration display band 1112 is configured such that its display is enabled over all display elements associated with system display bands 1114. In addition, band management component 1110 can be configured to prevent (e.g., via a policy engine component and/or any other suitable mechanisms) any other display elements from entering registration display band 1112 and interfering with its visibility. In one example, upon registration of the licensed element(s) of the computing system, registration display band 1112 can be disabled such that the registration watermark display no longer interferes with the visibility of system display bands 1114.

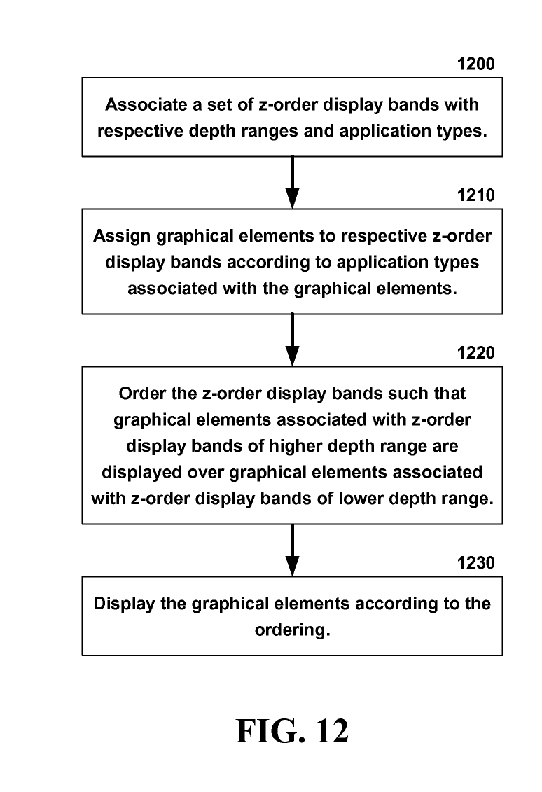

FIG. 12 is a flow diagram illustrating an exemplary non-limiting process for z-order display management. At 1200, a set of z-order display bands is associated with respective depth ranges and application types. At 1210, graphical elements are assigned to respective z-order display bands according to application types associated with the graphical elements. At 1220, the z-order display bands are ordered such that graphical elements associated with z-order display bands of higher (e.g., shallower) depth range are displayed over graphical elements associated with z-order display bands of lower (e.g., deeper) depth range. At 1230, the graphical elements are displayed according to the ordering performed at 1220.

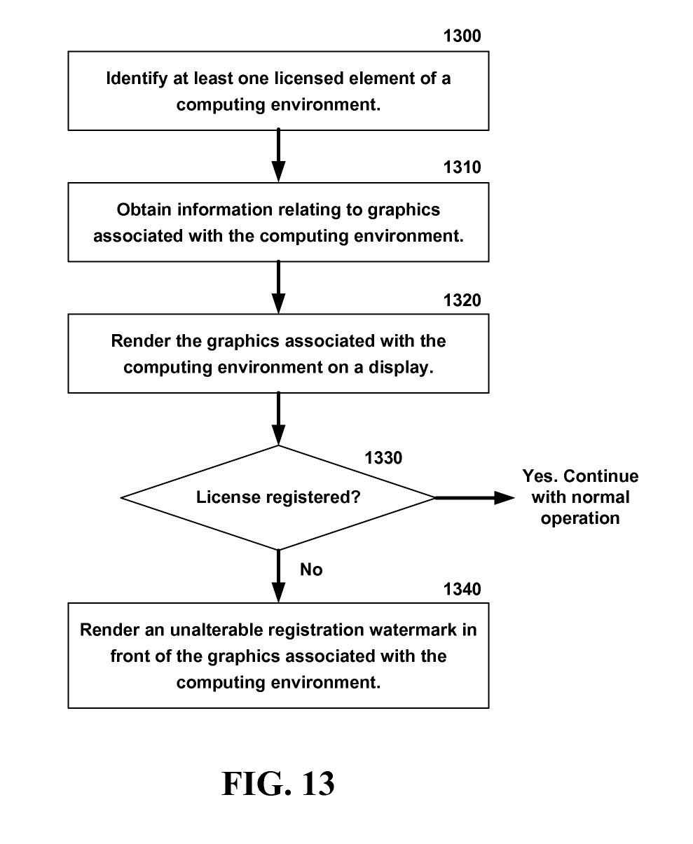

FIG. 13 is another flow diagram illustrating an exemplary non-limiting process for registration watermarking of a computer display. At 1300, at least one licensed element of a computing environment (e.g., an operating system, application, etc.) is identified. At 1310, information is obtained that relates to graphics associated with the computing environment. At 1320, the graphics associated with the computing environment are rendered on a display. At 1330, it is determined whether a license associated with the licensed application(s) has been registered. If the license has been registered, normal operation continues. Otherwise, at 1340, an unalterable registration watermark is rendered in front of the graphics associated with the computing environment.

### Exemplary Networked and Distributed Environments

One of ordinary skill in the art can appreciate that the various embodiments of the display management systems and methods described herein can be implemented in connection with any computer or other client or server device, which can be deployed as part of a computer network or in a distributed computing environment. In this regard, the various embodiments described herein can be implemented in any computer system or environment having any number of memory or storage units, and any number of applications and processes occurring across any number of storage units. This includes, but is not limited to, an environment with server computers and client computers deployed in a network environment or a distributed computing environment, having remote or local storage.

Distributed computing provides sharing of computer resources and services by communicative exchange among computing devices and systems. These resources and services include the exchange of information, cache storage and disk storage for objects, such as files. These resources and services also include the sharing of processing power across multiple processing units for load balancing, expansion of resources, specialization of processing, and the like. Distributed computing takes advantage of network connectivity, allowing clients to leverage their collective power to benefit the entire enterprise. In this regard, a variety of devices may have applications, objects or resources that may participate in the display management mechanisms as described for various embodiments of the subject disclosure.

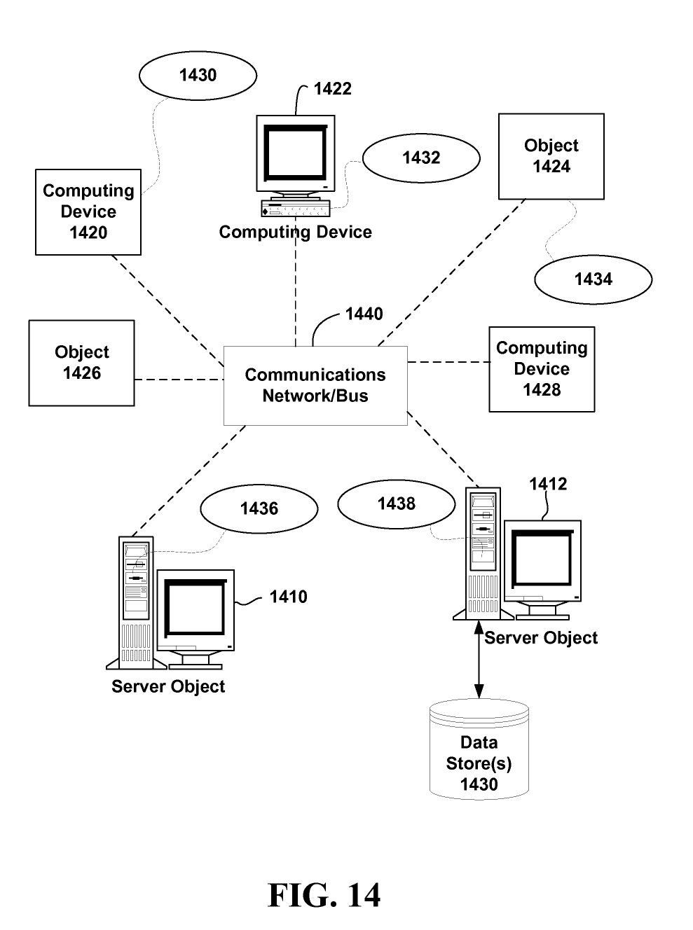

FIG. 14 provides a schematic diagram of an exemplary networked or distributed computing environment. The distributed computing environment comprises computing objects 1410, 1412, etc. and computing objects or devices 1420, 1422, 1424, 1426, 1428, etc., which may include programs, methods, data stores, programmable logic, etc., as represented by applications 1430, 1432, 1434, 1436, 1438. It can be appreciated that computing objects 1410, 1412, etc. and computing objects or devices 1420, 1422, 1424, 1426, 1428, etc. may comprise different devices, such as personal digital assistants (PDAs), audio/video devices, mobile phones, MP3 players, personal computers, laptops, etc.

Each computing object 1410, 1412, etc. and computing objects or devices 1420, 1422, 1424, 1426, 1428, etc. can communicate with one or more other computing objects 1410, 1412, etc. and computing objects or devices 1420, 1422, 1424, 1426, 1428, etc. by way of the communications network 1440, either directly or indirectly. Even though illustrated as a single element in FIG. 14, communications network 1440 may comprise other computing objects and computing devices that provide services to the system of FIG. 14, and/or may represent multiple interconnected networks, which are not shown. Each computing object 1410, 1412, etc. or computing object or device 1420, 1422, 1424, 1426, 1428, etc. can also contain an application, such as applications 1430, 1432, 1434, 1436, 1438, that might make use of an API, or other object, software, firmware and/or hardware, suitable for communication with or implementation of the display management techniques provided in accordance with various embodiments of the subject disclosure.

There are a variety of systems, components, and network configurations that support distributed computing environments. For example, computing systems can be connected together by wired or wireless systems, by local networks or widely distributed networks. Currently, many networks are coupled to the Internet, which provides an infrastructure for widely distributed computing and encompasses many different networks, though any network infrastructure can be used for exemplary communications made incident to the display management systems as described in various embodiments.

Thus, a host of network topologies and network infrastructures, such as client/server, peer-to-peer, or hybrid architectures, can be utilized. The “client” is a member of a class or group that uses the services of another class or group to which it is not related. A client can be a process, i.e., roughly a set of instructions or tasks, that requests a service provided by another program or process. The client process utilizes the requested service without having to “know” any working details about the other program or the service itself.

In a client/server architecture, particularly a networked system, a client is usually a computer that accesses shared network resources provided by another computer, e.g., a server. In the illustration of FIG. 14, as a non-limiting example, computing objects or devices 1420, 1422, 1424, 1426, 1428, etc. can be thought of as clients and computing objects 1410, 1412, etc. can be thought of as servers where computing objects 1410, 1412, etc., acting as servers provide data services, such as receiving data from client computing objects or devices 1420, 1422, 1424, 1426, 1428, etc., storing of data, processing of data, transmitting data to client computing objects or devices 1420, 1422, 1424, 1426, 1428, etc., although any computer can be considered a client, a server, or both, depending on the circumstances.

A server is typically a remote computer system accessible over a remote or local network, such as the Internet or wireless network infrastructures. The client process may be active in a first computer system, and the server process may be active in a second computer system, communicating with one another over a communications medium, thus providing distributed functionality and allowing multiple clients to take advantage of the information-gathering capabilities of the server. Any software objects utilized pursuant to the techniques described herein can be provided standalone, or distributed across multiple computing devices or objects.

In a network environment in which the communications network 1440 or bus is the Internet, for example, the computing objects 1410, 1412, etc. can be Web servers with which other computing objects or devices 1420, 1422, 1424, 1426, 1428, etc. communicate via any of a number of known protocols, such as the hypertext transfer protocol (HTTP). Computing objects 1410, 1412, etc. acting as servers may also serve as clients, e.g., computing objects or devices 1420, 1422, 1424, 1426, 1428, etc., as may be characteristic of a distributed computing environment.

### Exemplary Computing Device

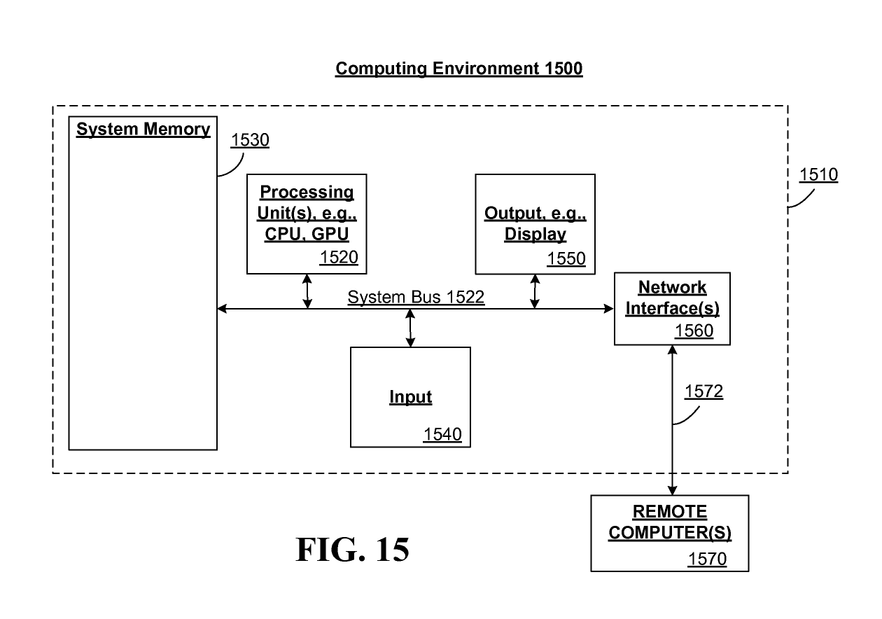

As mentioned, advantageously, the techniques described herein can be applied to any device where it is desirable to perform display management in a computing system. It can be understood, therefore, that handheld, portable and other computing devices and computing objects of all kinds are contemplated for use in connection with the various embodiments, i.e., anywhere that a computing system display device may be utilized. Accordingly, the below general purpose remote computer described below in FIG. 15 is but one example of a computing device.

Although not required, embodiments can partly be implemented via an operating system, for use by a developer of services for a device or object, and/or included within application software that operates to perform one or more functional aspects of the various embodiments described herein. Software may be described in the general context of computer-executable instructions, such as program modules, being executed by one or more computers, such as client workstations, servers or other devices. Those skilled in the art will appreciate that computer systems have a variety of configurations and protocols that can be used to communicate data, and thus, no particular configuration or protocol should be considered limiting.

FIG. 15 thus illustrates an example of a suitable computing system environment 1500 in which one or aspects of the embodiments described herein can be implemented, although as made clear above, the computing system environment 1500 is only one example of a suitable computing environment and is not intended to suggest any limitation as to scope of use or functionality. Neither should the computing system environment 1500 be interpreted as having any dependency or requirement relating to any one or combination of components illustrated in the exemplary computing system environment 1500.

With reference to FIG. 15, an exemplary remote device for implementing one or more embodiments includes a general purpose computing device in the form of a computer 1510. Components of computer 1510 may include, but are not limited to, a processing unit 1520, a system memory 1530, and a system bus 1522 that couples various system components including the system memory to the processing unit 1520.

Computer 1510 typically includes a variety of computer readable media and can be any available media that can be accessed by computer 1510. The system memory 1530 may include computer storage media in the form of volatile and/or nonvolatile memory such as read only memory (ROM) and/or random access memory (RAM). By way of example, and not limitation, system memory 1530 may also include an operating system, application programs, other program modules, and program data.

A user can enter commands and information into the computer 1510 through input devices 1540. A monitor or other type of display device is also connected to the system bus 1522 via an interface, such as output interface 1550. In addition to a monitor, computers can also include other peripheral output devices such as speakers and a printer, which may be connected through output interface 1550.

The computer 1510 may operate in a networked or distributed environment using logical connections to one or more other remote computers, such as remote computer 1570. The remote computer 1570 may be a personal computer, a server, a router, a network PC, a peer device or other common network node, or any other remote media consumption or transmission device, and may include any or all of the elements described above relative to the computer 1510. The logical connections depicted in FIG. 15 include a network 1572, such local area network (LAN) or a wide area network (WAN), but may also include other networks/buses. Such networking environments are commonplace in homes, offices, enterprise-wide computer networks, intranets and the Internet.

As mentioned above, while exemplary embodiments have been described in connection with various computing devices and network architectures, the underlying concepts may be applied to any network system and any computing device or system in which it is desirable to improve user experience with respect to a computing system display.

Also, there are multiple ways to implement the same or similar functionality, e.g., an appropriate API, tool kit, driver code, operating system, control, standalone or downloadable software object, etc. which enables applications and services to take advantage of the techniques provided herein. Thus, embodiments herein are contemplated from the standpoint of an API (or other software object), as well as from a software or hardware object that implements one or more embodiments as described herein. Thus, various embodiments described herein can have aspects that are wholly in hardware, partly in hardware and partly in software, as well as in software.

The word “exemplary” is used herein to mean serving as an example, instance, or illustration. For the avoidance of doubt, the subject matter disclosed herein is not limited by such examples. In addition, any aspect or design described herein as “exemplary” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used, for the avoidance of doubt, such terms are intended to be inclusive in a manner similar to the term “comprising” as an open transition word without precluding any additional or other elements.

As mentioned, the various techniques described herein may be implemented in connection with hardware or software or, where appropriate, with a combination of both. As used herein, the terms “component,” “system” and the like are likewise intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it can be noted that one or more components may be combined into a single component providing aggregate functionality or divided into several separate sub-components, and that any one or more middle layers, such as a management layer, may be provided to communicatively couple to such sub-components in order to provide integrated functionality. Any components described herein may also interact with one or more other components not specifically described herein but generally known by those of skill in the art.

In view of the exemplary systems described supra, methodologies that may be implemented in accordance with the described subject matter can also be appreciated with reference to the flowcharts of the various figures. While for purposes of simplicity of explanation, the methodologies are shown and described as a series of blocks, it is to be understood and appreciated that the various embodiments are not limited by the order of the blocks, as some blocks may occur in different orders and/or concurrently with other blocks from what is depicted and described herein. Where non-sequential, or branched, flow is illustrated via flowchart, it can be appreciated that various other branches, flow paths, and orders of the blocks, may be implemented which achieve the same or a similar result. Moreover, not all illustrated blocks may be required to implement the methodologies described hereinafter.

In addition to the various embodiments described herein, it is to be understood that other similar embodiments can be used or modifications and additions can be made to the described embodiment(s) for performing the same or equivalent function of the corresponding embodiment(s) without deviating therefrom. Still further, multiple processing chips or multiple devices can share the performance of one or more functions described herein, and similarly, storage can be effected across a plurality of devices. Accordingly, the invention should not be limited to any single embodiment, but rather should be construed in breadth, spirit and scope in accordance with the appended claims.

What is claimed is:

1. A graphical display management system, comprising:
a band management component configured to define a set of z-order bands, to associate relative z-order ranges with z-order bands of the set of z-order bands, to assign display elements to respective z-order bands of the set of z-order bands, and to generate a linear order of the z-order bands such that first display elements assigned to a first z-order band of the set of z-order bands associated with a first z-order range are displayed in front of display elements assigned to a second z-order band of the set of z-order bands associated with a second z-order range that is deeper than the first z-order range; and
a display component configured to render the display elements according to the linear order of the z-order bands.

2. The system according to claim 1, wherein z-order bands of the set of z-order bands correspond to respective application types.

3. The system according to claim 1, wherein the band management component comprises:
a policy engine component configured to maintain a set of policies utilized by the band management component to assign the display elements to the respective z-order bands of the set of z-order bands.

4. The system according to claim 3, wherein the policy engine component is further configured to maintain a set of entrance policies and a set of exit policies that respectively control entry and exit of the display elements into respective z-order bands of the set of z-order bands.

5. The system according to claim 3, wherein the policy engine component is further configured to maintain a set of enforcement policies that control movement of the display elements between z-order bands of the set of z-order bands.

6. The system according to claim 1, wherein respective z-order bands of the set of z-order bands are configured with display properties and the display component is further configured to render the display elements according to the display properties with which their respectively assigned z-order bands are configured.

7. The system according to claim 6, wherein the display properties include at least one of display format properties, windowing rules, full-screen display properties, or graphical element sizes.

8. The system according to claim 1, wherein the band management component is further configured to assign the display elements to the respective z-order bands of the set of z-order bands based at least in part on user preferences.

9. The system according to claim 1, wherein the band management component comprises:
a band creation component configured to create at least one z-order band, to assign the at least one z-order band to at least one corresponding z-order range, and to associate the at least one z-order band with the set of z-order bands.

10. The system according to claim 1, wherein the band management component comprises:
a band reordering component configured to alter the z-order ranges with which respective z-order bands of the set of z-order bands are associated.

11. The system according to claim 10, wherein the band reordering component is further configured to alter the z-order ranges with which respective z-order bands of the set of z-order bands are associated based at least in part on user input.

12. The system according to claim 1, further comprising:
a per-band ordering component configured to associate z-order positions with display elements assigned to a z-order band of the set of z-order bands;
wherein the display component is further configured to render the display elements assigned to the z-order band of the set of z-order bands according to respective z-order positions, and wherein display elements associated with a first z-order position are displayed in front of display elements assigned to a second z-order position that is deeper than the first z-order position.

13. The system according to claim 1, further comprising:
a registration component configured to facilitate registration of a computing environment associated with the display elements;
wherein the band management component is further configured to generate an unregistered display band and associate an unregistered graphical display with the unregistered display band if the computing environment associated with the system has not been registered by the registration component; and
wherein the display component is further configured to render the unregistered graphical display associated with the unregistered display band in front of the display elements if the computing environment associated with the system has not been registered by the registration component.

14. A method for managing a computer display, comprising:
associating a set of z-order display bands with respective depth ranges and application types;
assigning graphical elements to respective z-order display bands of the set of z-order display bands according to the application types associated with the graphical elements;
ordering the z-order display bands such that a first set of graphical elements assigned to a first z-order display band associated with a first depth range are displayed over a second set of graphical elements assigned to a second z-order display band associated with a second depth range that is z-dimensionally deeper than the first depth range; and
displaying the graphical elements according to the ordering.

15. The method of claim 14, wherein the assigning comprises:
assigning the graphical elements to the respective z-order display bands of the set of z-order display bands based at least in part on a set of band management policies.

16. The method of claim 15, wherein the assigning further comprises at least one of:
controlling entry of graphical elements into the respective z-order display bands of the set of z-order display bands based at least in part on a set of band entrance policies;
controlling exit of graphical elements into the respective z-order display bands of the set of z-order display bands based at least in part on a set of band exit policies; or
controlling movement of graphical elements between z-order display bands of the set of z-order display bands based at least in part on a set of band enforcement policies.

17. The method of claim 14, wherein:
the method further comprises associating z-order display bands of the set of z-order display bands with respective display properties, the display properties comprising at least one of display format properties, windowing rules, full-screen display properties, or graphical element sizes; and
the displaying comprises displaying the graphical elements according to the display properties associated with the z-order display bands of the set of z-order display bands to which the graphical elements are assigned.

18. The method of claim 14, wherein the assigning comprises:
assigning graphical elements to respective z-order display bands of the set of z-order display bands based at least in part on user preferences.

19. The method of claim 14, further comprising:
modifying the set of z-order display bands via at least one of adding one or more z-order display bands to the set of z-order display bands, removing one or more z-order display bands from the set of z-order display bands, combining one or more z-order display bands of the set of z-order display bands, or reordering the depth ranges associated with one or more z-order display bands of the set of z-order display bands.

20. A system that facilitates graphical display, comprising:
a registration component configured to facilitate registration of a license for at least one licensed element of a computing system;
a band management component configured to associate a registration display with a registration display band and to associate respective graphics of the computing system with at least one system display band; and
a display component configured to render the respective graphics and, if the license has not been registered via the registration component, to render the registration display associated with the registration display band in front of the respective graphics and to prevent the respective graphics from being moved in front of the registration display.
